(19) United States
(12) Patent Application Publication
(10) Pub. No.: US 2007/0211355 A1
(43) Pub. Date: Sep. 13, 2007

(54) Foot imaging device

(75) Inventors: Ansley R. Dalbo, Decatur, GA (US); Robert T. Quest, Alpharetta, GA (US)

Correspondence Address: BRENDA POMERANCE;LAW OFFICE OF BRENDA POMERANCE, 260 WEST 52 STREET SUITE 27B, NEW YORK, NY, 10019, US

(73) Assignee: Arcadia Group LLC, Atlanta, GA (US)

(21) Appl. No.: 11/374,540

(22) Filed: Mar. 13, 2006

(51) Int. Cl. G02B 7/182

(52) U.S. Cl. 359/871

(57) ABSTRACT

Several ways are provided for a person to obtain an image of the soles of their feet while sitting near a foot imaging device, standing near the device, or standing on the device. In one embodiment, a device on the floor has a reflective surface having an adjustable angle relative to the floor. In another embodiment, a mirror is placed beneath the surface of a foot imaging device that incorporates a weight scale. Additionally, the surface of the device can incorporate a way for the user to detect loss of sensation in the soles of the feet, such as a sandpaper surface, a dull probe or a thermal stimulator. In a further embodiment, the device incorporates an image capture device that can send an image of the feet to a local display, to a local computer such as a personal computer having storage, display and print capability, or to a remote device such as a medical or insurance provider's computer, where it can be viewed for diagnostic purposes or simply retained to demonstrate that a patient has carried out the imaging operation.

### BACKGROUND OF THE INVENTION

The present invention relates to a foot imaging device with a mirror and/or camera for taking or reflecting an image of the soles of the user's feet. The foot imaging device may be combined with a weight scale.

Diabetes is a chronic disease that is reaching epidemic proportions. Currently, about 21 million Americans have diabetes, and 1.5 million new cases are diagnosed annually. It is estimated that 1 in 3 children born in 2000 will develop diabetes in their lifetime. The World Health Organization projects that by the year 2025, there will be 25 million diabetics in the United States and over 300 million diabetics worldwide. It is estimated that 60-70% of these individuals will develop foot-related afflictions in their lifetimes.

More than half of all lower limb amputations in the United States occur in people with diabetes. Currently, this is about 82,000 amputations annually. It has been estimated that nearly half of these amputations are caused by neuropathy and poor circulation, and could have been prevented by careful foot care, including daily foot self-inspections.

Diabetic neuropathies are a family of nerve disorders caused by diabetes. People with diabetes can, over time, have damage to nerves throughout the body. Neuropathies lead to numbness and sometimes pain and weakness in the hands, arms, feet, and legs. People with diabetes can develop nerve problems at any time, but the longer a person has diabetes, the greater the risk. An estimated 50 percent of those with diabetes have some form of neuropathy that can be detected upon examination, but not all with neuropathy have symptoms. The most common type is peripheral neuropathy, also called distal symmetric neuropathy, which affects the arms and legs. Symptoms of peripheral neuropathy may include: numbness or insensitivity to pain or temperature, a tingling, burning, or prickling sensation, sharp pains or cramps, extreme sensitivity to touch, even a light touch, or loss of balance and coordination. Foot deformities, such as hammertoes and the collapse of the mid-foot, may occur. Blisters and sores may appear on numb areas of the foot because pressure or injury goes unnoticed.

If foot injuries are not treated promptly, the infection may spread to the bone, and the foot may then have to be amputated. Some experts estimate that half of all such amputations are preventable if minor problems are caught and treated in time.

While daily foot self-examinations are typically recommended for diabetics, many do not follow the recommendation for reasons including: the diabetic is too obese to see the soles of their feet, the diabetic forgets to do the self-exam, and/or does not get around to it because doing so is awkward or cumbersome.

Thus, there is a need for a way to assist diabetics with their foot self-examinations.

A mirror located on a telescoping pole has been used to assist diabetics who lack the physical flexibility to see the soles of their feet.

FIG. 1 shows a proposed bathroom personal care environment. Mirror surface 10 and flat display 20 form a mirror display device. Without power, the mirror display device functions like a standard mirror. With power, the mirror display device displays information in the foreground with mirror surface 10 serving as the background. The information can be a television signal or a reading from a personal care device such as weight scale 70. More specifically, weight scale 70 includes local weight display 80 and antenna 75 as well as circuitry to capture a weight reading and format it for transmission via antenna 75. The transmission follows a low-power radio frequency protocol such as ZigBee. At the mirror display device, receiving antenna 45 receives the weight scale reading, and via transmission interface 40 under control of processor 50, passes the weight scale reading to display interface 30, which serves to control flat display 20 to display the weight scale reading. The personal care environment is responsive to spoken commands and possibly gestured commands. However, the personal care environment is not adapted to the special needs of diabetics.

### SUMMARY OF THE INVENTION

In accordance with an aspect of this invention, there is provided a floor based imaging device for reflecting an image of a user's foot, comprising a protective enclosure having a substantially transparent top surface, and a reflecting surface positioned inside the enclosure to reflect an image through the top surface of the protective enclosure.

The reflecting surface is at an angle relative to a floor located underneath the protective enclosure. Angle adjustment means are provided for adjusting the angle of the reflecting surface relative to the floor.

In accordance with another aspect of this invention, there is provided a floor based imaging device for reflecting an image of a user's foot, comprising a platform located parallel to a floor for being stepped upon by the user, and a reflecting surface located in a fixed position relative to the platform to generate a reflection directed away from the floor.

In some cases, a protective surface is located over the reflecting surface. The protective surface can open to reveal the reflecting surface, or can change its light transmission property to reveal the reflecting surface. A magnifying surface may be located under the reflecting surface, sometimes with guide rails supporting edges of the magnifying surface so that the magnifying surface can be pulled from underneath the reflecting surface. There may be a light source for illuminating the reflecting surface. There may be a weight display for displaying the weight of the user when the user steps on the platform, the weight display being removable from the platform.

In some cases, there may be a neuropathy detector, which may be a monofilament and/or a tactile surface.

In accordance with a further aspect of this invention, there is provided a floor based imaging device for capturing an image of a user's foot, comprising a platform located parallel to a floor for being stepped upon by the user, an image capture surface located in a fixed position under the platform to capture an image of what is on the platform, and an image transmission circuit for sending the captured image to another device for display or processing.

There may also be a display device for displaying the captured image. The connection between the image transmission circuit and the display device may be wireline or wireless. The image capture surface may be located in a camera. The captured image may be sent to a computer for processing, the computer being at a different location than the floor based imaging device.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 is a diagram of a prior art bathroom personal care environment;

FIGS. 2A-2B are diagrams of a floor-based mirror;

FIGS. 3A-3F are diagrams of a foot mirror with a weight scale;

FIGS. 4A-4B are diagrams of a weight scale with a pull-out mirror;

FIGS. 5A and 5B are views of a foot imaging device with closed cover and open cover;

FIGS. 6A-6C are views of a foot imaging device incorporating a camera and attached display;

FIGS. 7A-7C are views of a foot imaging device with image transmission capability; and

FIG. 8 is a diagram of a foot imaging care environment.

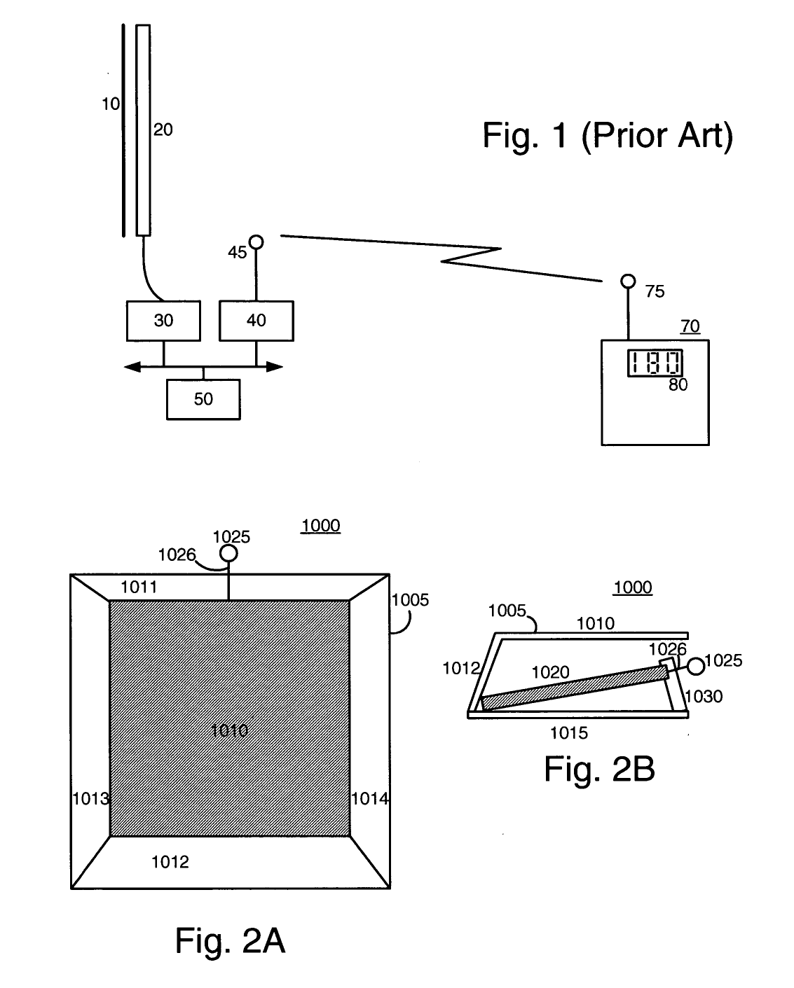

### DETAILED DESCRIPTION

The present invention provides several ways for a person to obtain an image of the soles of their feet while sitting near a foot imaging device, standing near the device, or standing on the device. In one embodiment, a device on the floor has a reflective surface having an adjustable angle relative to the floor. In another embodiment, a mirror is placed beneath the surface of a foot imaging device that incorporates a weight scale. Additionally, the surface of the device can incorporate a way for the user to detect loss of sensation in the soles of the feet, such as a sandpaper surface, a dull probe or a thermal stimulator. In a further embodiment, the device incorporates an image capture device that can send an image of the feet to a local display, to a local computer such as a personal computer having storage, display and print capability, or to a remote device such as a medical or insurance provider's computer, where it can be viewed for diagnostic purposes or simply retained to demonstrate that a patient has carried out the imaging operation.

FIGS. 2A-2B are views of a floor based device 100 for reflecting the soles of a user's feet. Device 1000 comprises clear sturdy enclosure 1005, formed of a material such as plexiglass, enclosing reflective surface 1020 whose angle relative to the floor can be adjusted in the range of 0°-45° or other suitable angle. Enclosure 1005 has top surface 1010, top edge 1011, side edges 1012, 1013, bottom edge 1014 and base 1015.

Reflective surface 1020 is formed of mirror glass or other reflective surface, and is located in enclosure 1005 so that a reflection is visible to the user. Shaft 1026 projects from the top edge of reflective surface 120. Angle adjustment knob 1025 is located at the distal end of shaft 1025. Shaft 1026 is movable along a track-like opening in angle adjustment member 1030. Angle adjustment knob 1025, shaft 1026 and angle adjustment member 1030 cooperate to enable adjustment by the user of the angle of reflective surface 1020 relative to the floor.

In one embodiment, angle adjustment member 1030 has a threaded track-like opening, shaft 1026 is threaded, and the user turns knob 1025 to raise or lower reflective surface 1020. In another embodiment, angle adjustment member 1030 has an opening with shelf-like protrusions, and the user employs knob 1025 to place shaft 1026 on one of the shelf-like protrusions to thereby adjust the height of the top of reflective surface 1020 relative to the floor. Other angle adjustment mechanisms will be apparent to those of ordinary skill.

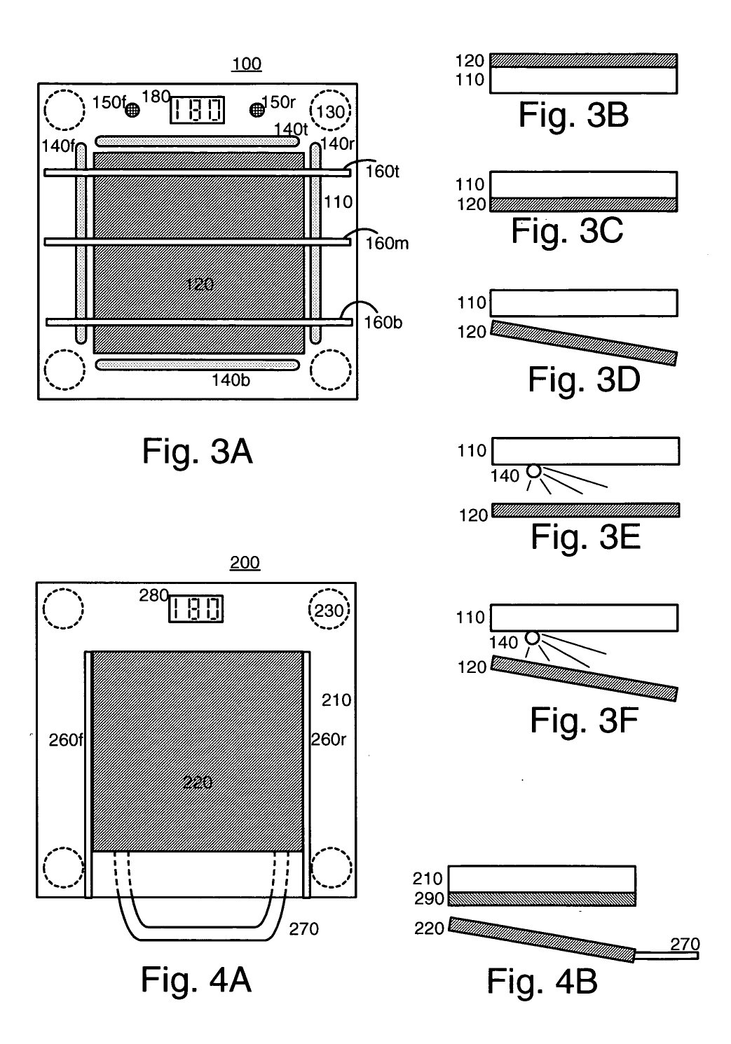

FIG. 3A is a diagram of foot mirror 100. Foot mirror 100 includes platform 110, mirror surface 120, four platform feet 130 at respective corners of foot mirror 100, light emitting strips 140t, 140b, 140r and 140f, collectively 140, at the top, bottom, right and left of mirror surface 120, monofilaments 150r, 150f, collectively 150, at the right and left sides of foot mirror 100, sensitivity lines 160t, 160m, 160b, collectively 160, at the top, middle and bottom of foot mirror 100, and local weight display 180, which may be detachable from platform 110 for wall mounting or the like.

As used herein and in the claims, “mirror” means a reflective surface, not limited to coated glass. For example, plastic treated to be reflective is an example of a mirror.

In embodiments where weight display 180 is detachable from platform 110, the detachable unit communicates with control electronics (not shown) coupled to platform 110 via a suitable channel, such as a tethered cord or wireless infra-red, low power, radio frequency or other communication technique.

In operation, a user steps on platform 110, and a weight sensor (not shown) detects the user's weight and adjusts weight display 180, which may be a printed dial or a light emitting diode (LED) display or other suitable display. In some embodiments, a sound generator serves to speak the user's weight. In some embodiments, other sensors are provided such as body fat sensors.

The user can view the soles of his or her feet, typically by holding one foot over mirror surface 120, and then holding the other foot over mirror surface 120. Mirror surface 120 may provide a normal or magnified reflection.

FIGS. 3B-3F are partial side views of variations of mirror surface 120. In FIG. 3B, mirror surface is on top of platform 110, such as a silvery coating. A problem with this arrangement is that mirror surface 120 is susceptible to scratches, smudges and dirt. In the variation of FIG. 3C, platform 110 is on top of mirror surface 120, which may now be coated glass, or simply a reflective coating on the underside of platform 110. Platform 110 is formed of a transparent material such as plexiglass.

In the variation of FIG. 3D, mirror surface 120 is underneath platform 110, and mirror surface 120 is placed at an angle with the top being elevated above the bottom, such as on a support platform (not shown), so that when the user steps on platform 110, the undesirable straight-up view of the user's body does not occur. An angle adjustment mechanism, such as shown in FIGS. 2A-2B, may also be provided for mirror surface 120, to adjust its angle relative to platform 110 and the floor.

In the embodiment of FIG. 3E, light emitting device 140, such as a lamp activated when the user steps on platform 110, provides substantially brighter illumination at the top of mirror surface 120, which is flat relative to the floor. Light emitting device 140 is attached to the underside of platform 110 towards its bottom edge, to ensure more even illumination of mirror surface 120. In FIG. 3F, mirror surface 120 is inclined relative to the floor, to avoid the undesirable straight-up view of the user's body.

Returning to FIG. 3A, light emitting strips 140 serve to illuminate mirror surface 120 so that it is easier for the user to inspect the soles of his or her feet. In one embodiment, when the user steps on platform 110, light emitting strips 140 are activated for a predetermined amount of time. In another embodiment, light emitting strips 140 are activated when the user applies pressure thereto. In yet another embodiment, there is a switch (not shown) for the user to manually activate light emitting strips 140.

Foot mirror 100 includes two foot sensitivity testers, monofilament 150 and sensitivity line 160.

Monofilaments are used to measure the patient's ability to sense a point of pressure. The rationale for testing the ability of a patient to sense pressure is that repeated bouts of moderate amounts of unnoticed pressures are thought to be the primary mechanism for development of plantar ulcers in patients with diabetes and peripheral neuropathy. The history of the use of various filaments to test for the presence or absence of sensation dates back to the 1800s when Von Frey used horsehairs for testing patients' sensation thresholds. In 1960, Dr. Josephine Semmes and Dr. Sidney Weinstein developed a more sophisticated set of medical grade sensory testing monofilaments. Their premise was that an increased diameter of a monofilament would be accompanied by a required increased force needed to create a bend in the monofilament when it was applied to the surface to be tested. They created a progressive scale of monofilaments for neurologic sensory testing. Monofilaments are assigned manufacturer-calibrated numbers that range from 1.65 to 6.65. The higher the number, the stiffer the filament. The formula utilized is as follows: Marking=(log₁₀ Force(in milligrams)×10). The 5.07 monofilament has been accepted as the medical standard for screening of the minimum level of protective sensation in the foot. The reproducible buckling stress force required to bend the 5.07 monofilament is 10 grams of force.

Monofilament 150 is a cylinder of 10-gauge nylon about 3 inches in length and having a diameter of about 1-3 millimeters, although other sizes can be used. The user touches the tip of monofilament 150 to an area alongside an ulcer, callous or scar on the foot sole for 1-2 seconds, and similarly touches designated areas of the foot sole for 1-2 seconds. If sensation is not felt, the user contacts a medical care provider.

Sensitivity strip 160 is a tactile strip made out of textured plastic, sandpaper or the like. In operation, the user passes the sole of his or her foot across sensitivity strip 160, and if sensation is not felt, contacts a medical care provider. In other embodiments, sensitivity strip 160 is formed of thermally variable material, such as plastic or metal that heats when the user steps on platform 110; if the heat is not felt, the user contacts a medical care provider. In other embodiments, sensitivity strip 160 is merely textured for skid resistance.

Other manifestations of sensitivity strip 160 will be apparent to those of ordinary skill in the art of mechanical device design and who have experience with diabetic neuropathy.

Other neuropathy testing devices may be employed. For example, U.S. Pat. No. 6,090,050, “Thermometric Apparatus and Method”, discloses a thermal sensor at the end of a gooseneck shaft for recording temperatures after sensing contact with, or proximity to, a dermal surface. Diagnosis is made using temperatures acquired from scanning both feet of a patient, and alarming when a hot spot is found. It has been found that an increase in local skin temperature is one of the earliest indications of tissue injury or inflammation, so monitoring foot skin temperature is a way to detect ulcer risks. Specifically, a thermal sensor (not shown) may be placed on foot mirror 100, in similar manner as shown for monofilament 150.

FIG. 4A is a diagram of foot mirror 200. Foot mirror 200 includes platform 210, mirror surface 220, four platform feet 230 at respective corners of foot mirror 200, guide rails 260r, 260f, collectively 260, at the right and left sides of mirror surface 220, handle 270, and local weight display 280, which may be detachable from platform 210 for wall mounting or the like. Platform 210 is typically transparent, although in some embodiments it is translucent or opaque.

The embodiment of FIG. 4A is similar to that of FIG. 3A, and only differences will be discussed.

In operation, the user grasps handle 270 attached to mirror surface 220, and pulls mirror surface 220 from underneath platform 210 along guide rails 260. Thus, even if platform 210 is scratched or smudged, a clean mirror surface is available for sole viewing. After the foot soles are inspected, the user pushes handle 270 to return mirror surface 220 to its resting position underneath platform 210. In a variation, instead of guide rails 260 that engage with the edges of mirror surface 220, there is a drawer for holding mirror surface 260, and the drawer engages with the guide rails.

FIG. 4B is a partial side view of foot mirror 200. The underside of platform 210 has reflective coating 290 serving as a first mirror surface. Then, second mirror surface 220 pulls out as needed for a closer view; first mirror surface 290 is typically a first magnification, such as none, and second mirror surface 220 is typically a second magnification, such as 50% magnification or some other amount higher than that provided by first mirror surface 290.

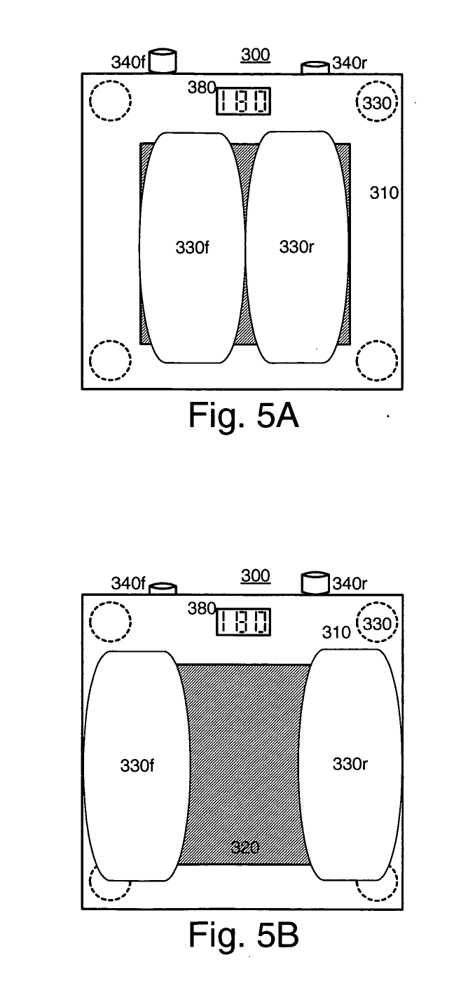

FIGS. 5A and 5B are views of foot mirror 300 with closed cover and open cover. Foot mirror 300 includes platform 310, mirror surface 320, four platform feet 330 at respective corners of foot mirror 300, shutters 330r, 330f, collectively 330, at the right and left sides of mirror surface 320, actuators 340r, 340f, and local weight display 380, which may be detachable from platform 310 for wall mounting or the like.

The embodiment of FIGS. 5A and 5B is similar to that of FIG. 3A, and only differences will be discussed.

Shutters 330 are located underneath transparent platform 310 and serve to protect mirror surface 320. In the closed position, shown in FIG. 5A, shutters 330 occlude mirror surface 320 either completely or at least substantially. When the user wishes to examine his or her foot soles, actuator 340f, which serves as an “open” button is depressed, causing shutters 330 to move apart to the open position shown in FIG. 5B. After the examination is complete, the user depresses actuator 340r, which serves as a “closed” button, causing shutters 330 to move together to the closed position shown in FIG. 5A.In some embodiments, foot mirror 300 includes a periodic reminder device (not shown) that reminds the user to perform a foot examination. The periodic reminder device may emit an alarm at periodic time intervals since the last time that the shutters were opened, or according to another scheme.

In another embodiment, instead of mechanical shutters 330, platform 310 alters from opaque to transparent, corresponding to closed and open shutters. In this case, platform 310 is formed of or coated with a suitable material whose light transmission characteristics are alterable, such as liquid crystal.

The embodiments described above rely on reflection to create a foot image. A reflection is a transient event. It is desirable to capture the foot image, so that it can be readily manipulated for display, storage, processing and transmission. The embodiments described below rely on foot image capture.

The various features of the embodiments discussed above may also be incorporated in the embodiments discussed below.

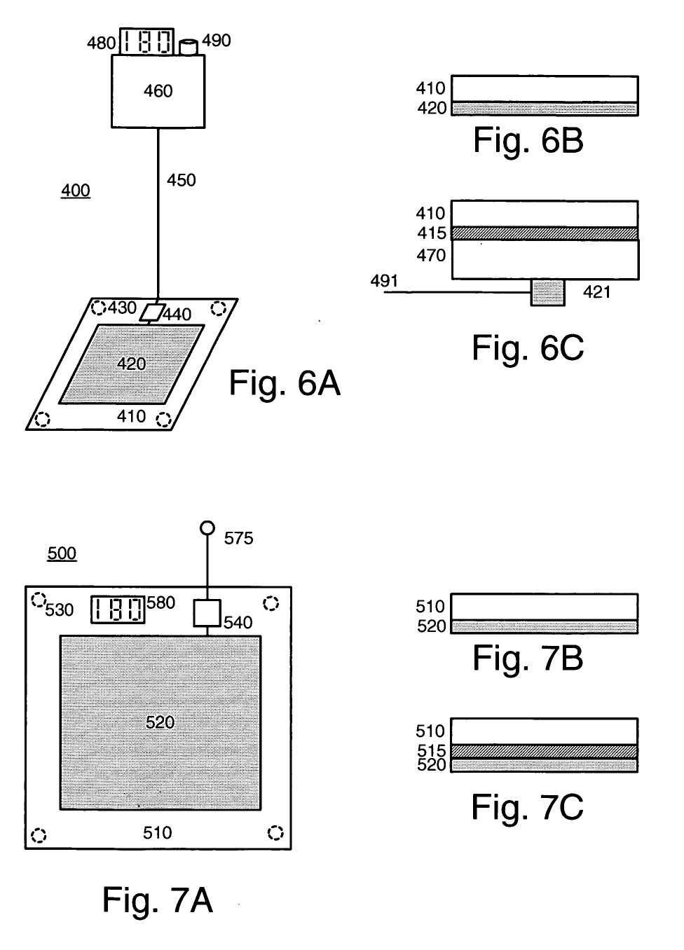

FIG. 6A is a view of foot imaging device 400. Foot imaging device 400 includes platform 410, image capture surface 420, four platform feet 430 at respective corners of foot imaging device 400, transmission/reception circuit 440, tether 450, foot image display 460, weight display 480 and actuator 490.

Tether 450 includes means for transmitting signals between actuator 490 and transmission/reception circuit 440, and between transmission/reception circuit 440 and foot image display 460. In one embodiment, tether 450 is a flexible electrical cord enabling wall mounting or table mounting of the combination of foot image display 460, weight display 480 and actuator 490. In another embodiment, tether 450 is part of a freestanding vertical member that supports the combination of foot image display 460, weight display 480 and actuator 490.

In operation, a user steps on platform 410 with his or her feet centered on the area of image capture surface 420. As shown in FIG. 6B, image capture surface 420 is located on the underside of platform 410. Platform 410 is preferably a transparent material such as plexiglass. Image capture surface 420 is an arrangement of image capture elements such as photodiodes, photoconductive sensors, integrated circuits or other suitable sensor assemblies.

After stepping on platform 410, the user actuates actuator 490, such as by pressing the button. In some cases, the act of stepping on platform 410 serves as actuation, and actutator 490 is omitted. Instead of a manually depressed button, actuator 490 may be voice activated, or responsive to another suitable stimulus. Actuator 490 causes transmission/reception circuit 440 to activate image capture surface 420 and take an electronic snapshot at that instant, and to deliver the electronic snapshot to foot image display 460. Foot image display 460 is a flat panel display, or may be any suitable display device.

When the user steps on platform 410, a weight sensor (not shown) detects the user's weight and adjusts weight display 480. The weight sensor may use transmission/reception circuit 440 to communicate with weight display 480, or may use another communication channel.

The fact that foot image display 460 is closer to the eyes of the user than if it were attached to platform 410 is advantageous for people with poor vision, and people whose body shape precludes them from seeing their feet and/or a display on platform 410. Additionally, the proximity of the foot image has a psychological effect, making the foot sole seem closer to one's heart.

FIG. 6C is a partial side view showing a variation of foot imaging device 400 wherein off-the-shelf camera 421 substitutes for image capture surface 420. Actuator 490 communicates with camera 421 via communication path 491; in some embodiments path 491 is mechanical and activates an image capture button on camera 421, while in other embodiments path 491 is electrical and communicates with control circuitry inside camera 421 to motivate image capture. Spacer 470, which may be air or a transparent material, is interposed between camera 421 and platform 410. Also, mirror surface 415 is under platform 410, to provide a reflection as described above. Mirror surface 415 enables some light to pass through and be captured by camera 421. In some embodiments, mirror surface 415 is absent.

In the embodiment of FIG. 6C, after the image is captured by camera 421, camera 421 is removed. In some cases, camera 421 has a built-in display of sufficient resolution for viewing the just-captured image. In other cases, camera 421 is coupled to a separate display or printer (not shown) to create a user-visible image.

FIG. 7A is a view of foot imaging device 500. Foot imaging device 500 includes platform 510, image capture surface 520, four platform feet 530 at respective corners of foot imaging device 500, processing circuit 540, antenna 575 and weight display 580.

When a user steps on platform 510, a weight sensor (not shown) detects the user's weight and adjusts weight display 580. Additionally, image capture surface 520 is activated and captures an image of the soles of the user's feet. Via processing circuit 540, the captured image is transmitted through antenna 575 to a receiving device.

In one embodiment, the receiving device is a proximate display. In another embodiment, shown in FIG. 10, the receiving device is a proximate computer. As used herein, proximate means within the same building or dwelling place. In a further embodiment, processing circuit 540 is capable of initiating a call on a wireless communication network, and dials a preprogrammed destination such as a server computer and sends the captured image thereto.

In a modification, instead of capturing one image, image capture surface 520 is continually read, and serves as a video camera to continuously update a display or provide a video stream of information.

FIGS. 7B-7C are partial side views of embodiments of foot imaging device 500. As shown in FIG. 7B, image capture surface 520 is located underneath platform 510. As shown in FIG. 7C, reflective surface 515 is interposed between the underside of platform 510 and image capture surface 520, so that the user can see a reflected image of the soles of their feet.

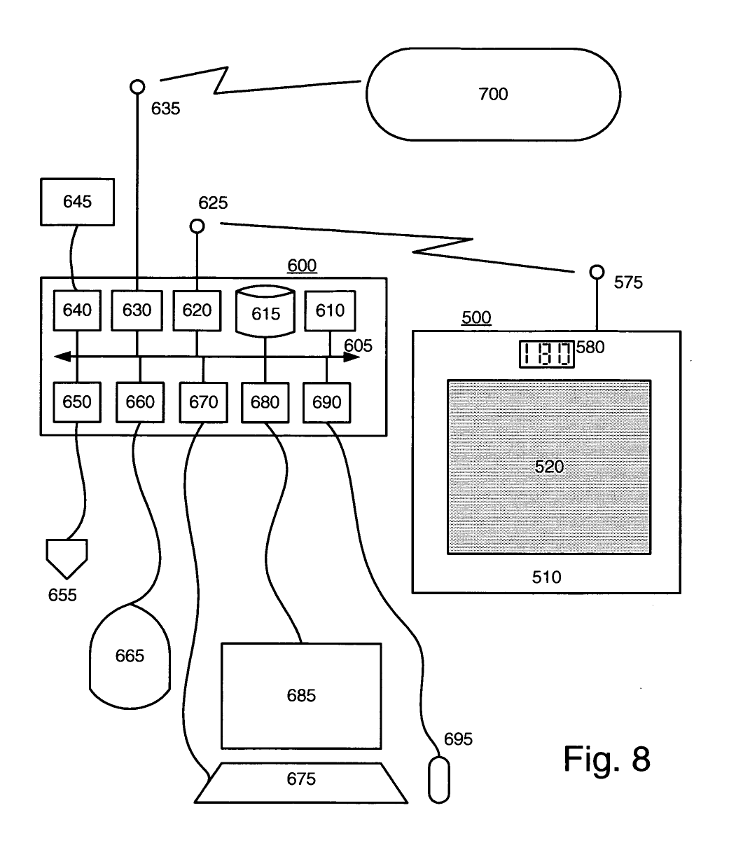

FIG. 8 is a diagram of a foot imaging care environment, including foot imaging device 500, computer 600 and communication network 700. Foot imaging device 500 is discussed above with regard to FIGS. 7A-7C.

Communication network 700 may be a public or private network operating on wireline and/or wireless circuits, using circuit-switched or packet-switched technology, or any other protocol that is suitable for transmitting information. Examples include the dial-up public switched telephone network, a private network of dedicated circuits, the Internet, the cellular telephone system, WiMax networks and so on. Communication network 700 serves to link computer 600 to a remote computer (not shown), such as a computer operated by or on behalf of a medical care provider or a medical insurer.

Computer 600 includes internal bus 605, processor 610, storage 615, local communication interface 620, remote communication interface 630, printer interface 640, device interfaces 650, 660 according to a standard such as USB, PCMCIA or other, keyboard interface 670, display interface 680 and pointing device interface 690. Coupled to computer 600 via suitable wireline or wireless channel are printer 645, biometric sensors 655, 665, keyboard 675, display 685 and pointing device 695, which may be a separate mouse or incorporated in keyboard 675 as a trackball or touch pad or the like.

Local communication interface 620 serves to enable transmission and reception of information between computer 600 and foot imaging device 500.

Remote communication interface 630 serves to enable transmission and reception of information between computer 600 and a remote computer (not shown), via communication network 700, such as a computer operated by or on behalf of a medical care provider or a medical insurer.

Biometric sensors 655, 665 may be any form of sensor of a user's activity. Examples include a blood pressure monitor, a blood glucose monitor, a pedometer, a body fat tester and so on. Although two sensors are shown, another number may be used. In some cases, instead of a sensor, the user enters biometric information manually, using the keyboard or pointing device, or other suitable interface (not shown) such as a microphone cooperating with voice recognition software executed by processor 610.

Some use cases for the foot imaging care environment will now be discussed.

In one case, the user steps on foot imaging device 500, which captures an image of the soles of the user's feet and sends the image to computer 600. Computer 600 stores the image and displays it on display 685. The user can print the image on printer 645.

In another case, computer 600 sends received foot images to the user's medical care provider via communication network 700. The images can be sent when received, or collected into a batch and sent as needed, as requested or at periodic intervals.

In another case, computer 600 has software for comparing images of the user's feet and automatically issuing an alert when a possible trouble area is detected. In response to the alert, the user may be instructed to take another image of their feet, to contact their medical services provider, or other suitable action.

In another case, computer 600 enables the user to manipulate the feet image, such as to zoom in on certain areas, or to request a comparison of selected stored feet images.

In another case, information from other biometric sensors is correlated with one or more feet images. For example, the number and size of potential lesions may be plotted against blood glucose levels and/or user's weight.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A floor based imaging device for reflecting an image of a user's foot, comprising:
a protective enclosure having a substantially transparent top surface, and a reflecting surface positioned inside the enclosure to reflect an image through the top surface of the protective enclosure.

2. The device of claim 1, wherein the reflecting surface is at an angle relative to a floor located underneath the protective enclosure.

3. The device of claim 2, further comprising angle adjustment means for adjusting the angle of the reflecting surface relative to the floor.

4. A floor based imaging device for reflecting an image of a user's foot, comprising:
a platform located parallel to a floor for being stepped upon by the user, and
a reflecting surface located in a fixed position relative to the platform to generate a reflection directed away from the floor.

5. The device of claim 4, further comprising a protective surface located over the reflecting surface.

6. The device of claim 5, wherein the reflecting surface is at an angle relative to the platform.

7. The device of claim 6, further comprising angle adjustment means for adjusting the angle of the reflecting surface relative to the platform.

8. The device of claim 5, wherein the protective surface opens to reveal the reflecting surface.

9. The device of claim 5, wherein the protective surface changes its light transmission property to reveal the reflecting surface.

10. The device of claim 4, further comprising a magnifying surface located under the reflecting surface.

11. The device of claim 10, further comprising guide rails supporting edges of the magnifying surface so that the magnifying surface can be pulled from underneath the reflecting surface.

12. The device of claim 4, further comprising a light source for illuminating the reflecting surface.

13. The device of claim 4, further comprising a weight display for displaying the weight of the user when the user steps on the platform.

14. The device of claim 13, wherein the weight display is removable from the platform.

15. The device of claim 4, further comprising a neuropathy detector.

16. The device of claim 15, wherein the neuropathy detector is a monofilament.

17. The device of claim 15, wherein the neuropathy detector is a tactile surface.

18. A floor based imaging device for capturing an image of a user's foot, comprising:
a platform located parallel to a floor for being stepped upon by the user,
an image capture surface located in a fixed position under the platform to capture an image of what is on the platform, and
an image transmission circuit for sending the captured image to another device for display or processing.

19. The device of claim 18, further comprising a display device for displaying the captured image.

20. The device of claim 19, further comprising a wireline connection between the image transmission circuit and the display device.

21. The device of claim 19, further comprising a wireless connection between the image transmission circuit and the display device.

22. The device of claim 18, further comprising a reflecting surface located in a fixed position relative to the platform to generate a reflection directed away from the floor.

23. The device of claim 22, further comprising a protective surface located over the reflecting surface.

24. The device of claim 22, wherein the reflecting surface is at an angle relative to the platform.

25. The device of claim 24, further comprising angle adjustment means for adjusting the angle of the reflecting surface relative to the platform.

26. The device of claim 22, further comprising a light source for illuminating the reflecting surface.

27. The device of claim 18, further comprising a weight display for displaying the weight of the user when the user steps on the platform.

28. The device of claim 27, wherein the weight display is removable from the platform.

29. The device of claim 18, further comprising a neuropathy detector.

30. The device of claim 18, wherein the image capture surface is located in a camera.

31. The device of claim 18, wherein the captured image is sent to a computer for processing.

32. The device of claim 31, wherein the computer is at a different location than the floor based imaging device.
